(19) United States
(12) Patent Application Publication
(10) Pub. No.: US 2024/0053442 A1
(43) Pub. Date: Feb. 15, 2024

(54) Laser Rangefinder

(71) Applicant: Bihu Jiaxiao Photoelectric Technology (Chongqing) Co., Ltd., Chongqing (CN)

(72) Inventor: Xianlong Fu, Chongqing (CN)

(21) Appl. No.: 18/496,810

(22) Filed: Oct. 27, 2023

Related U.S. Application Data
(63) Continuation of application No. 17/155,113, filed on Jan. 22, 2021.

(51) Int. Cl. G01S 7/481; G02B 23/02

(52) U.S. Cl. CPC G01S 7/4813; G02B 23/02; G02B 25/001

(57) ABSTRACT

The present disclosure provides a laser rangefinder including a micro control unit, a power supply, a transmitter, a receiver, a light emitting module and a display unit, wherein the power supply, the transmitter, the receiver, the light emitting module and the display unit are electrically connected with the micro control unit, and the light emitting module includes a photosensitive element, a light emitting element and an LED control board.

### CROSS-REFERENCE TO RELATED APPLICATIONS

This application is a Continuation of the U.S. application Ser, No. 17155113 filed on Jan. 22, 2021, and entitled “Laser Rangefinder”, now pending, the entire disclosures of which are incorporated herein by reference.

### FIELD OF THE INVENTION

The present invention relates to the field of range-finding devices, and more particularly relates to a laser rangefinder.

### BACKGROUND OF THE INVENTION

Golf is a club-and-ball sport in which players use various clubs to hit balls into a series of holes in as few strokes as possible after players confirm the distance of the holes. If players know the accurate distance, they can choose the right club according to their own situation, therefore the range-finding of the hole on the course has an important influence on the score.

In order to confirm the distance and direction of the hole, players usually set up a flagpole in the hole and use a distance measuring device to measure the distance. At present, there are two common golf hole ranging devices in the market: laser ranging device and GPS ranging device.

Laser ranging device does not rely on GPS coordinates, but its accuracy is easily affected by the user's operating. Usually, a user aims the laser ranging device at an object through the center of a viewfinder of the laser ranging device. Once the object is in the center, laser beam can be activated, and the laser beam is emitted by the device towards the target object. The laser beam is reflected by the object, and part of the laser beam returns to the laser ranging device. The device calculates the distance of the target object according to the time difference of the returned laser beam and displays the distance, so that the user can understand the distance between the target object and himself more conveniently, and control the swing strength better.

However, traditional laser ranging devices have the following problems:
1. When the distance is displayed, the number displayed is generally pure black, which is not convenient for users to observe when the ambient light is dark;
2. Although there is also distance measuring device displaying red number, it uses OLED, which has high cost and can not automatically detect light according to the external environment, which is still not conducive to the observation of users.

### SUMMARY OF THE INVENTION

The purpose of the present invention is to provide a laser rangefinder which is conducive to the observation of users.

A laser rangefinder includes a micro control unit, a power supply, a transmitter, a receiver, a light emitting module and a display unit, wherein the power supply, the transmitter, the receiver, the light emitting module and the display unit are electrically connected with the micro control unit, and the light emitting module comprises a photosensitive element, a light emitting element and an LED control board.

Preferably, the transmitter includes a transmitting high voltage circuit, a transmitting driving module and a transmitting tube, and the receiver includes a receiving high voltage circuit, a receiving driving module, an avalanche photodiode and a signal processor.

Preferably, the laser rangefinder further includes an angle position sensor electrically connected with the micro control unit.

The present invention further provides a laser rangefinder including a shell; a telescope, a laser transmitting system and a laser receiving system received in the shell, wherein the telescope comprises an objective lens, a prism, an eyepiece group and a display unit arranged at the focal plane position of the eyepiece group, the laser emitted by the laser transmitting system refracts by the prism and shoots on the measured target, and the laser reflected by the measured target is received by the laser receiving system; and a photosensitive module configured to detect the light intensity of a tested object.

Preferably, the laser transmitting system includes a semiconductor laser transmitter and a transmitting lens, and the laser receiving system includes a receiving lens, a filter and a photoelectric receiving tube.

Preferably, the transmitting lens is arranged on the semiconductor laser transmitter.

Preferably, the display unit includes a liquid crystal screen, a light board and a light guide plate arranged in order, wherein the light board is composed of an LED and a circuit board, and the light guide plate irradiates light on the liquid crystal screen.

Preferably, the laser rangefinder further includes a reflective paper arranged behind the light guide plate.

Preferably, the photosensitive module includes a lens and a photosensitive resistor, which are used for measuring the light intensity of the a target to control the brightness of the light plate. The laser rangefinder of the present disclosure includes a shell; a telescope, a laser transmitting system and a laser receiving system received in the shell, wherein the telescope comprises an objective lens, a prism, an eyepiece group and a display unit arranged at the focal plane position of the eyepiece group, the laser emitted by the laser transmitting system refracts by the prism and shoots on the measured target, and the laser reflected by the measured target is received by the laser receiving system; and a photosensitive module configured to detect the light intensity of a tested object. As the displayed number of the laser rangefinder changes with the light intensity of the target, the color of the displayed number is changed, and because the color of the number is displayed according to the color of the LED light, it is convenient for users to observe.

### BRIEF DESCRIPTION OF THE DRAWINGS

The following drawings of the present invention are used to understand the invention as a part of it. The drawings show an embodiment and the description of the embodiment, so as to explain the principle of the invention, in which:

FIG. 1 shows the decomposition diagram of the laser rangefinder of the present invention;

FIG. 2 shows the structure diagram of the laser rangefinder of the present invention.

### DETAILED DESCRIPTION OF THE EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the size and the relative dimension of layers and areas may be exaggerated for clear. Like numbers refer to like elements throughout.

It should be understood that if a component or a layer is described as “on”, “adjacent to”, “connected to” or “coupled to” another component or layer, it may be directly configured on, adjacent to, connected to or coupled to the other component, or there may be a mediate component or a mediate layer. Rather, if a component or a layer is described as “directly on”, “directly adjacent to”, “directly connected to” or “directly coupled to” another component or layer, mediate component or mediate layer does not exist.

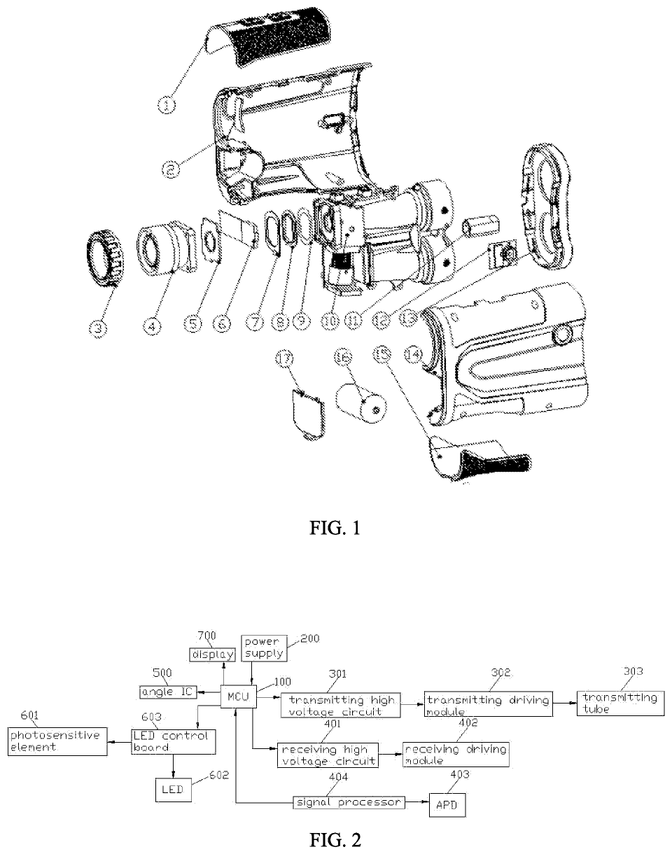

As shown in FIG. 1, the present disclosure provides a laser rangefinder including a shell composed of a left shell 2 and a right shell 14. The shell is also provided with an upper rubber 1 and a lower rubber 15, which are used to improve the hand feeling of holding the laser rangefinder.

The upper rubber 1 is provided with a start key and a mode key. The start key is used for transmitting laser, and the mode key is used for mode conversion.

The laser rangefinder further includes a telescope, a laser transmitting system 10 and a laser receiving system received in the shell. The telescope includes an objective lens, a prism, an eyepiece group 4, an eyepiece cover 3 covered by the eyepiece group 4, a light baffle 5 arranged behind the eyepiece group and a display unit arranged at the focal plane of the eyepiece group.

The laser emitted by the laser transmitting system 10 is refracted by the prism and projected onto the measured target, and the laser reflected by the measured target is received by the laser receiving system. The laser transmitting system 10 includes a semiconductor laser transmitter and a transmitting lens, and the laser receiving system includes a receiving lens, a filter and a photoelectric receiving tube. The transmitting lens is arranged in the semiconductor laser transmitter, and the laser enters the eyepiece through the objective lens, prism and display unit in turn. The laser emitted by the semiconductor laser transmitter is emitted through the transmitting lens, and the light signal is reflected after reaching the measured target. The reflected light signal is received by the photoelectric receiving tube after passing through the objective lens, prism, receiving lens and filter. The laser receiving system consists of a receiving lens, a filter and a photoelectric receiving tube. The reflected laser is received by the photoelectric receiving tube after passing through the receiving lens and the filter in turn.

The display unit includes a liquid crystal screen 6, a light board 7 and a light guide plate 8 arranged in turn, wherein the light board 7 is composed of an LED and a circuit board, and the light guide plate 8 irradiates light on the liquid crystal screen 6. The laser rangefinder further includes an LED control board 12 and a main board 13. In the present embodiment, a reflective paper 9 is arranged behind the light guide plate 8 to prevent the light of the light guide plate 8 from shining behind the prism and reflecting in the eyepiece 4 to form stray light and affect the visual effect.

The laser rangefinder further includes a photosensitive module 11, which comprises a lens and a photosensitive resistor, and is used to measure the light intensity of the end target, so as to control the brightness of the light board, and to achieve the effect of changing the depth of the color display of the liquid crystal screen 6 with the change of the light intensity of the target.

In the present embodiment, the laser rangefinder further includes a battery 16 housed in the housing and a battery cover 17 fixed to the housing.

The working principle of the laser ranging device is: when the start key is pressed, the main board 13 sends a signal to the liquid crystal screen 6 and the LED control board 12, and the photosensitive module 11 starts to detect the light intensity of the target, and sends a signal to the LED control board 12 to control the brightness of the light board 7. The light of the light board 7 shines on the reflective paper 9, the reflective paper 9 reflects the light to the light guide plate 8, and the light is guided to the liquid crystal screen 6 through the light guide plate 8, so that the liquid crystal screen 6 changes the color of the font display. When it is not necessary to change the display color, press the switch of the LED control panel 12, the LED control panel 12 stops detecting the signal from the photosensitive module 11, and the LED control panel 12 no longer controls the light board 7 to light up.

The laser rangefinder of the present disclosure includes a shell; a telescope, a laser transmitting system and a laser receiving system received in the shell, wherein the telescope comprises an objective lens, a prism, an eyepiece group and a display unit arranged at the focal plane position of the eyepiece group, the laser emitted by the laser transmitting system refracts by the prism and shoots on the measured target, and the laser reflected by the measured target is received by the laser receiving system; and a photosensitive module configured to detect the light intensity of a tested object. As the displayed number of the laser rangefinder changes with the light intensity of the target, the color of the displayed number is changed, and because the color of the number is displayed according to the color of the LED light, it is convenient for users to observe.

As shown in FIG. 2, the present disclosure provides a laser rangefinder including a micro control unit (MCU) 100, a power supply 200 electrically connected with the MCU 100, a transmitter, a receiver, an angle position sensor (angle IC) 500, a light emitting module and a display 700. The transmitter 300 includes a transmitting high voltage circuit 301, a transmitting driving module 302 and a transmitting tube 303, and the receiver includes a receiving high voltage circuit 401, a receiving driving module 402, an avalanche photodiode (APD) 403 and a signal processor 404. The angle position sensor (angle IC) 500 is used to measure the angle of the target, and the avalanche photodiode (APD) 403 is used to amplify the photoelectric signal to improve the detection sensitivity.

The display 700 is a liquid crystal display, and the light-emitting module includes a photosensitive element 601, a light-emitting element 602 and an LED control board 603. Specifically, the photosensitive element includes a lens and a photosensitive resistor for sensing the light intensity of the measured object. The light-emitting element includes an LED and a light guide board, and the display is arranged in turn with the LED and the light guide board. In the present embodiment, the reflective paper is set behind the light guide plate to avoid forming stray light and affecting the visual effect.

Since the color of the number is displayed according to the color of the LED light, and the displayed number of the laser rangefinder changes with the light intensity of the target, the color of the displayed number is changed, it is convenient for users to observe.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A laser rangefinder, comprising a micro control unit, a power supply, a transmitter, a receiver, a light emitting module and a display unit, wherein the power supply, the transmitter, the receiver, the light emitting module and the display unit are electrically connected with the micro control unit, and the light emitting module comprises a photosensitive element, a light emitting element and an LED control board.

2. The laser rangefinder according to claim 1, wherein the transmitter comprises a transmitting high voltage circuit, a transmitting driving module and a transmitting tube, and the receiver comprises a receiving high voltage circuit, a receiving driving module, an avalanche photodiode and a signal processor.

3. The laser rangefinder according to claim 2, further comprising an angle position sensor electrically connected with the micro control unit.

4. A laser rangefinder, comprising
a shell;
a telescope, a laser transmitting system and a laser receiving system received in the shell, wherein the telescope comprises an objective lens, a prism, an eyepiece group and a display unit arranged at the focal plane position of the eyepiece group, the laser emitted by the laser transmitting system refracts by the prism and shoots on the measured target, and the laser reflected by the measured target is received by the laser receiving system; and
a photosensitive module configured to detect the light intensity of a tested object.

5. The laser rangefinder according to claim 4, wherein the laser transmitting system comprises a semiconductor laser transmitter and a transmitting lens, and the laser receiving system comprises a receiving lens, a filter and a photoelectric receiving tube.

6. The laser rangefinder according to claim 5, wherein the transmitting lens is arranged on the semiconductor laser transmitter.

7. The laser rangefinder according to claim 6, wherein the display unit comprises a liquid crystal screen, a light board and a light guide plate arranged in order, wherein the light board is composed of an LED and a circuit board, and the light guide plate irradiates light on the liquid crystal screen.

8. The laser rangefinder according to claim 7, further comprising a reflective paper arranged behind the light guide plate.

9. The laser rangefinder according to claim 8, wherein the photosensitive module comprises a lens and a photosensitive resistor, which are used for measuring the light intensity of the a target to control the brightness of the light plate.
